(19) United States
(12) Patent Application Publication
(10) Pub. No.: US 2003/0188601 A1
(43) Pub. Date: Oct. 9, 2003

(54) Integral auxiliary handlebar

(76) Inventors: Glenn P. Maslowsky, West Falls, NY (US); Janine S. Maslowsky, West Falls, NY (US)

Correspondence Address: S. Peter Konzel, Esq., Simpson & Simpson, PLLC, 5555 Main Street, Williamsville, NY, 14221-5406, US

(21) Appl. No.: 10/406,169

(22) Filed: Apr. 3, 2003

Related U.S. Application Data
(60) Provisional application No. 60/369,894, filed on Apr. 4, 2002.

(51) Int. Cl. B62K 21/12

(52) U.S. Cl. 74/551.8

(57) ABSTRACT

An integral auxiliary handlebar for a main handlebar generally comprises a neck portion operatively arranged to be secured to a main handlebar, an arcuate portion proximate the neck portion, a first straight handgrip portion proximate the arcuate portion, and a second straight handgrip portion proximate the first straight handgrip portion. The neck portion of the integral auxiliary handlebar generally comprises a C-shaped member operatively arranged to be clamed about the main handlebar. The integral auxiliary handlebar is solid throughout, yet lightweight to meet the needs of the competition bicyclist. The integral auxiliary handlebar is specifically configured to be secured a main handlebar of an off-road bicycle, but could be modified to be secured to any type of handlebar.

### CROSS REFERENCE TO RELATED APPLICATIONS

This non-provisional patent application claims the benefit under 35 U.S.C. §119(e) of U.S. Provisional Patent Application No. 60/369,894, which application was filed on Apr. 4, 2002.

### FIELD OF THE INVENTION

The present invention generally relates to handlebars for bicycles and the like, and more particularly, to integral auxiliary handlebars for attachment to the main handlebars of bicycles, and more specifically to integral auxiliary handlebars for off-road bicycles.

### BACKGROUND OF THE INVENTION

The two most widely attended competitions for bicycle enthusiasts are road racing tournaments, such as the Tour de France, and off-road bicycling tournaments, such as the Mountain Bike World Cup. Although these two types of bicycle racing are markedly different from one another (one is conducted on pavement and the other on off road-trails), training for the two types of competition is actually very similar. Indeed, both events are physically demanding, both require countless hours of “in the saddle” training, and both typically require that training be conducted on roadways. In simplest terms, whereas road racers have thousands of miles of easily accessible roads for training, the off-road bicyclist does not have thousands of miles of easily accessible trails. Thus, the off-road bicyclist is generally restricted to using roadways in order to train for off-road competitions.

Hence, to increase comfort and performance when training on the hard surfaces of roadways, many off-road bicyclists modify their bicycles for use on their paved surfaces. Replacement of an off-road bicycle's knobby tires with road tires, or slicks, is perhaps, the most common modification. However, simply changing the tires does not address other problems associated with using an off-road bicycle on the paved surfaces of roadways. Because they are designed to allow a rider to quickly react to changing off-road conditions and terrain, most off-road bicycles, in conjunction with the location of their handlebars, are designed such that a rider maintains a substantially upright, seated position. Such position is disadvantageous to the off-road cyclist during road training because the upright, seated position increases wind resistance and drag. Additionally, current off-road bicycle design makes it uncomfortable and difficult for a bicyclist to reduce drag by assuming a lowered, or crouched, position, which is more aerodynamic.

The primary reason that it is difficult and uncomfortable for an off-road bicyclist to assume a lowered, crouched position is largely attributed to the design and location of the off-road bicycle handlebars. Off-road bicycle handlebars do not allow a rider to position the hands in a lowered, forward position such that the crouched position can be maintained for extended periods of time. Thus, providing a lightweight integral auxiliary handlebar that is easily attachable and removable to and from the main handlebar would be particularly beneficial. Such handlebars would allow an off-road cyclist to maintain a lowered, crouched position, thereby reducing drag and increasing performance.

Currently, a number of auxiliary handlebars for different types of bicycles are known in the marketplace. Most types, however, are tubular, add too much weight to the bicycle, comprise bar ends that are not designed for assuming a lowered position, are unwieldy and cumbersome, prevent proper operation of the bicycle, or are not ergonomically designed for use with an off-road bicycle.

In the case of auxiliary handlebars for off-road bicycles, most comprise bar ends or aero bars that do not allow the off-road cyclist to maintain a substantially crouched position. One bar end for use with an off-road bicycle that allows a rider to maintain a crouched position is disclosed in U.S. Pat. No. 5,758,548 (Smith). This patented invention, however, comprises tubular auxiliary handlebars having multiple handgrip locations that attach at the ends of the main handlebar. Unfortunately, because of the many handgrip locations, the handlebars disclosed by Smith are unwieldy and cumbersome and prevent the bicyclist from being able to fully move the handlebars during turning operations. Another bar end for use with an off-road bicycle that allows a rider to assume a lowered crouched position is disclosed in U.S. Pat. No. 5,899,117 (Newkirk). This patented invention, however, is tubular and is attached to the terminal ends of the off-road bicycle handlebar. In addition, these bar ends are not designed for strength and weight reduction and they do not comprise multiple handgrip locations that are ergonomically designed for the comfort off the off-road cyclist.

Auxiliary handlebars for use with road bicycles are also known in the art; these handlebars typically comprise racing bars and aero bars. Examples of racing bars include the handlebars disclosed in U.S. Pat. No. 5,138,893 (Copeland), which illustrates an auxiliary racing bar for a road bicycle comprising two U-shaped tubes that are secured to a typical road bicycle handlebar. While these auxiliary handlebars allow a rider to achieve a lowered, crouched position, they comprise tubular, U-shaped bars and do not include multiple, ergonomic handgrip positions designed for the comfort of the off-road bicyclist. Similarly, U.S. Pat. No. 6,234,043 (Marshall) discloses an auxiliary handlebar for a road bicycle that is not ergonomically designed for off-road rider comfort. The Marshall design comprises tubular, V-shaped handlebars having straight portions whose handgrip locations extend outward. Additionally, the Marshall handlebars do not provide multiple gripping locations and are not ergonomically designed for the comfort of the off-road cyclist. Aero bars, on the other hand, are generally share the common characteristic that they are positioned above the main handlebar and do not allow a rider to assume a substantially lowered position.

Despite these known designs, lightweight and ergonomic integral auxiliary handlebars that allow the off-road cyclist to assume and maintain a comfortable, crouched position are heretofore unknown. Indeed, auxiliary handlebars for off-road bicycles exist in the marketplace, but they have proved unwieldy and cumbersome, prevent the proper operation of the bicycle, add too much weight to the bicycle, or have not provided sufficient comfort to the off-road cyclist. Hence, there is a longfelt need for a strong, lightweight, ergonomically designed integral auxiliary handlebar that allows an off-road cyclist to assume and maintain a comfortable, crouched position while providing maximum bicycle performance.

### BRIEF SUMMARY OF THE INVENTION

The present invention broadly comprises an integral auxiliary handlebar for a main handlebar comprising a neck portion operatively arranged to be secured to a main handlebar, an arcuate portion proximate the neck portion, a first straight handgrip portion proximate the arcuate portion, and a second straight handgrip portion proximate the first straight handgrip portion. The neck portion of the integral auxiliary handlebar generally comprises a C-shaped member operatively arranged for clamping about a main handlebar and more particularly, to the main handlebar of an off-road bicycle or hybrid bicycle. It should be appreciated by those having ordinary skill in the art, however, that while we disclose an auxiliary handlebar adapted primarily for use with off-road bicycles, the auxiliary handlebar of the present invention may be secured to any type of handlebar, for example, a motorcycle, scooter, etc.

Therefore, a general object of the present invention is to provide a strong, lightweight, ergonomic auxiliary handlebar for a bicycle.

Another object of the present invention is to provide a strong, lightweight, ergonomic auxiliary handlebar for use with an off-road bicycle or hybrid bicycle.

A further object of the present invention is to provide a strong, lightweight, ergonomic auxiliary handlebar for use with an off-road bicycle or hybrid bicycle, which allows a rider to assume and maintain a comfortable, crouched position so as to reduce wind resistance and drag thereby increasing performance.

Still yet another object of the present invention is to provide a strong, lightweight, ergonomic auxiliary handlebar for an off-road bicycle or hybrid bicycle that is easily attached and removed from a set of main handlebars for road and off-road bicycling conditions.

These and other objects, features and advantages of the present invention will become apparent upon reading the following detailed description of the invention in view of the several drawing figures and appended claims.

### BRIEF DESCRIPTION OF THE DRAWINGS

The invention will now be described in more detail with reference to the appended drawings in which:

FIG. 1 is a rear perspective view of the present invention;

FIG. 2 is a side view of the present invention;

FIG. 3 is a rear perspective view of the integral auxiliary handlebar of the present invention rotated about an angle to show the C-shaped member for clamping to a main handlebar.

FIG. 4 is a sectional view, taken along line 4-4 of FIG. 3, which shows the I-beam cross sectional geometry of the integral auxiliary handlebar, which geometry increases strength and reduces weight of the handlebar while providing comfort to the cyclist;

FIG. 5 is a rear view of the neck portion of the present invention showing the C-shaped member and fastening means for clamping to a main handlebar; and,

FIG. 6 shows the integral auxiliary handlebar of the present invention secured to a main handlebar of an off-road bicycle (Mountain, Hybrid, BMX, etc.)

### DETAILED DESCRIPTION OF THE INVENTION

In the detailed description that follows, identical reference numbers on different drawing views are intended to represent identical structural elements of the invention. Additionally, it should be appreciated that in the description that follows, the term “integral” as it applies to the present invention is intended to indicate that the neck portion, the arcuate portion, the first straight handgrip portion and the second straight handgrip portion of the auxiliary handlebar are all connected to one another in series and all comprise a single piece of material. The term “front” is intended to indicate that area of the handlebar of the present invention proximate the arcuate portion and the term “rear” is intended to indicate that area of the handlebar of the present invention comprising the second handgrip portion and end. “Rear view” as it refers to the figures is intended to generally describe that view from the end of the handle bar toward the arcuate portion. “Front view” is intended to generally describe that view from the arcuate portion of the handlebar toward the end. “Off-road” is intended to mean those bicycles designed for off-road use, including but not limited to: all terrain bicycles, mountain bicycles, trail bikes, BMX bicycles and/or hybrid bicycles.

It should be appreciated by those having skill in the art that although the present invention comprises an integral auxiliary handlebar for a main handlebar, and more particularly, an auxiliary handlebar for the main handlebar of an off-road bicycle, the present invention is intended to encompass auxiliary handlebars that may be used with other types of main handlebars, for example, road bicycles, motorcycles, scooters, etc. Finally, although a preferred embodiment comprises a solid, integral auxiliary handlebar constructed from a strong, lightweight plastic, other lightweight materials such as lightweight composites, metal alloys, etc. are contemplated, which materials do not depart from the spirit and scope of the invention as claimed. Additionally, other embodiments may comprise hollow integral auxiliary handlebars.

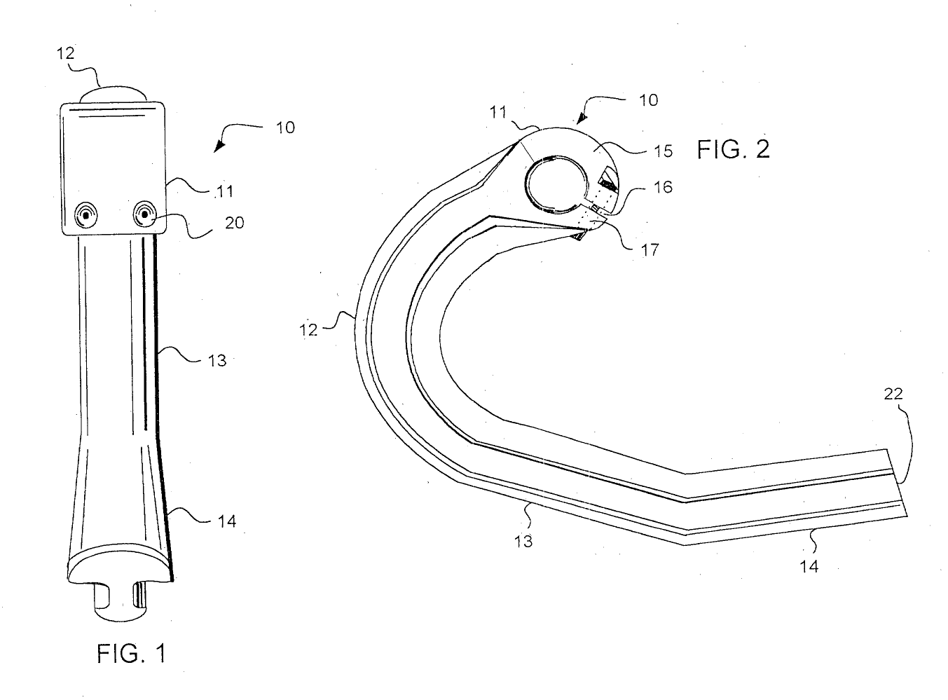

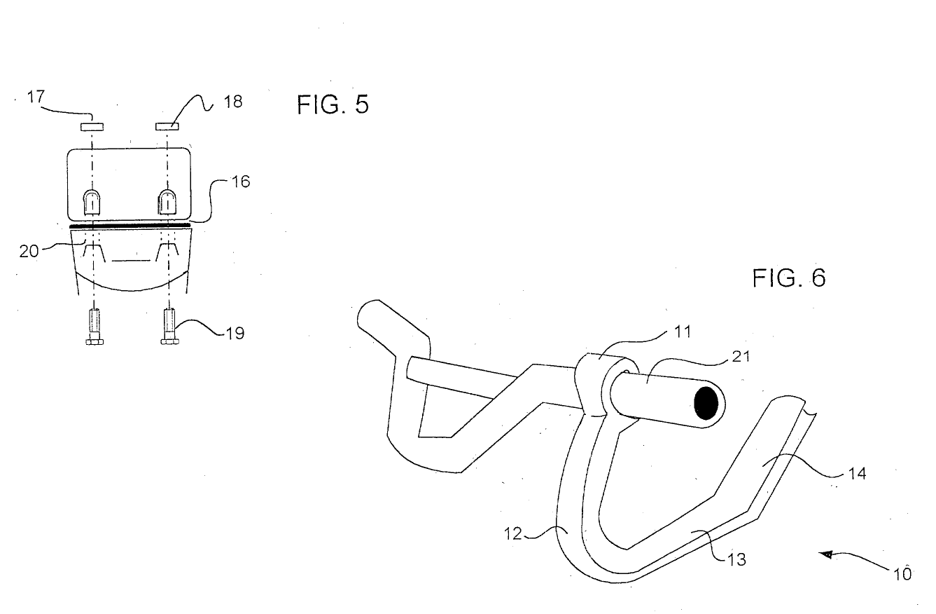

Adverting now to FIGS. 1 and 2, which are rear perspective and side views, respectively, of a preferred embodiment of the integral auxiliary handlebar 10 of the present invention. Integral auxiliary handlebar 10 generally comprises neck portion 11, arcuate portion 12, first straight portion 13 and second straight portion 14 connected to one another and constructed from a single piece of material. Neck portion 11 generally comprises C-shaped member 15, having slot 16 and bolt channels 20 for passing fastening means 17 therethrough. C-shaped member is operatively arranged for clamping about a main handlebar 21 (shown in FIG. 6) of a bicycle and secured thereto by fastening means 17. Fastening means 17 for clamping neck portion 11 generally comprise a plurality of nuts 18 and bolts 19 (shown in FIG. 5), which are fastened to one another through bolt channels 20 formed in C-shaped member 15 of neck portion 11. While means for securing the integral auxiliary handlebar of the present invention comprises C-shaped member 15 and fastening means 17, it should be appreciated by those having ordinary skill in the art that other means of fastening the integral auxiliary handlebar of the present invention to a main handlebar are contemplated, which means do not depart from the spirit and scope of the present invention as claimed. For example, neck portion could comprise separate, U-shaped members, which secure about a main handlebar and to one another to secure the auxiliary handlebar.

Referring now to FIG. 2, neck portion 11 is located proximate arcuate portion 12, and integrally connected thereto, and arcuate portion 12 is proximate first straight handgrip portion 13, and integrally connected thereto. In addition, first straight handgrip portion 14 is proximate second straight handgrip portion 15, and integrally connected thereto, and second straight handgrip portion extends therefrom and ceases to form end 22.

Arcuate portion 12 generally connects neck 11 to first straight handgrip portion 13. First straight handgrip portion 13 generally comprises a first handgrip surface ergonomically configured to enable the cyclist to assuming a lowered, crouched, position. Second straight handgrip portion 14 comprises an alternate handgrip surface ergonomically configured for assuming a crouched, yet slightly raised position. It should be appreciated by those having skill in the art that the integral auxiliary handlebar of the present invention could be rotationally positioned and secured about the main handlebar according to the needs, comfort, and desire of the user.

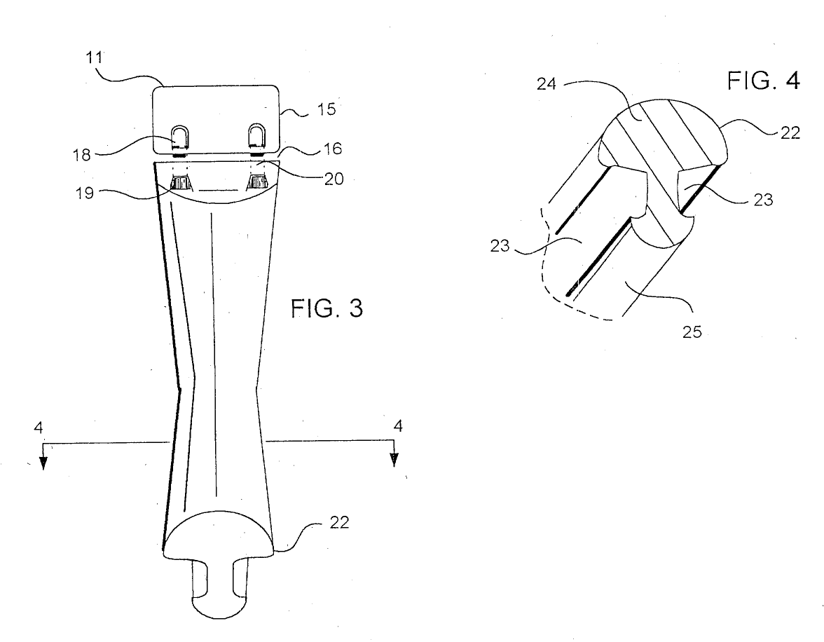

With reference now to FIGS. 3 and 4, in a preferred embodiment, integral auxiliary handlebar 10 of the present invention comprises solid NORYL® plastic, commercially available from GE Plastics of Pittsfield, Mass., which is injection molded to form the structure of the integral auxiliary handlebar. Additionally, FIGS. 3 and 4, show the solid, I-beam cross-sectional geometry 22 of the integral auxiliary handlebar of the present invention, which geometry provides increased strength while providing substantial weight reduction over conventional auxiliary handlebars. Weight reduction of the integral auxiliary handlebar is accomplished by means of channels 23, provided between upper rounded palm grips 24 and lower rounded finger grips 25 of the arcuate, first straight handgrip portions and second straight handgrip portions of the present invention. Upper rounded palm grips 24 generally comprise that surface upon which the palm of the hand rests when using the present invention; lower rounded finger grips 25 generally comprise that surface upon which the fingers rest when using the present invention. Additionally, it should be appreciated that upper rounded palm grips 24 increase the surface area upon which the hands rest and ultimately, reduce the amount of pressure that the hand applies to the handlebar. Thus, stress upon both the handlebar and the cyclist is reduced. Finally, while a preferred embodiment comprises NORYL® plastic having a solid, I-beam cross sectional configuration, other lightweight materials having similar strengths and weight reduction characteristics are contemplated, as are hollow structures.

Securing of the integral auxiliary handlebar of the present invention to a main handlebar of a bicycle is accomplished by sliding the channel formed by C-shaped member over an end of the main handlebar. The integral auxiliary handlebar is then slid along the main handlebar and rotated until a position, suitable and comfortable to the user, is achieved. The nuts and bolts are then tightened to secure the auxiliary handlebar to the main handlebar. It should be appreciated that increased friction between the C-shaped member and the main handlebar can be achieved by introducing appropriate materials therebetween. Additionally, it should be appreciate by those having ordinary skill in the art that other the means for securing the integral auxiliary handlebar of the present invention are contemplated. Moreover, it should also be appreciated that means for securing alternative embodiments of the present invention to a main handlebar will vary according to the structure of the neck portion. Removal of the auxiliary handlebar is easily achieved by reversing the steps of attachment.

Thus, it is seen that the objects of the present invention are efficiently obtained, although, it should be readily apparent to those having ordinary skill in the art that changes and modifications can be made to the invention without departing from the spirit and scope of the invention as claimed. It should especially be appreciated that the subject invention is intended to be solid and lightweight in construction and specifically configured for the off-road bicyclist, yet positionable to address the particular comfort needs of the user. Hence, it should be appreciated that variations of the integral auxiliary handlebar may be made, used and sold, and yet remain within the spirit and scope of the claims.

What is claimed is:

1. An integral auxiliary handlebar for a main handlebar comprising:
a neck portion, operatively arranged to be secured to said main handlebar;
an arcuate portion proximate said neck portion;
a first straight handgrip portion proximate said arcuate portion; and,
a second straight handgrip portion proximate said first straight handgrip portion.

2. The integral auxiliary handlebar recited in claim 1 wherein said neck portion comprises a C-shaped member operatively arranged to be clamped about said main handlebar.

3. The integral auxiliary handlebar as recited claim 1 wherein said auxiliary handlebar cross-sectional geometry comprises an I-beam configuration.

4. The integral auxiliary handlebar as recited in claim 3 wherein said I-beam is solid.

5. The integral auxiliary handlebar as recited in claim 3 wherein said I-beam is hollow.

6. The integral auxiliary handlebar as recited claim 1 wherein said handle bar is metal.

7. The integral auxiliary handlebar as recited claim 1 wherein said handlebar is non-metal.

8. The integral auxiliary handlebar as recited claim 1 comprising a solid structure.

9. The integral auxiliary handlebar as recited claim 1 comprising a hollow structure.

10. The integral auxiliary handlebar as recited in claim 1 operatively arranged to be secured to a bicycle.

11. The integral auxiliary handlebar as recited in claim 1 operatively arranged to be secured to an off-road bicycle.

12. The integral auxiliary handlebar as recited in claim 3 operatively arranged to be secured to an off-road bicycle.

13. The integral auxiliary handlebar as recited in claim 1 wherein said neck portion, said arcuate portion, said first handgrip portion and said second handgrip portion comprise channels for providing weight reduction.

14. A handlebar comprising:
an upper rounded palm grip surface portion;
a lower rounded finger grip surface portion;
an intermediate portion connecting said upper palm grip surface portion and said lower finger grip surface portion; said intermediate portion forming at least two parallel channels therebetween.

15. The handlebar as recited in claim 14 wherein the radius of said upper rounded surface portion is greater than the radius of said lower rounded finger grip surface portion.
